(19) United States
(12) Patent Application Publication
(10) Pub. No.: US 2007/0280180 A1
(43) Pub. Date: Dec. 6, 2007

(54) Wireless Communication System, Wireless Communication Device for Use as a Station in a Wireless Communication System, a Method of Communication Within a Wireless Communication System

(75) Inventors: Francesc Dalmases, Bellaterra - Barcelona (ES); Jorg Habetha, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,975

(22) PCT Filed: Jun. 8, 2005
(86) PCT No.: PCT/IB05/51866

§ 371 Date: Dec. 4, 2006

(30) Foreign Application Priority Data
Jun. 8, 2004 (EP) 04102603.0

(51) Int. Cl. H04L 12/28

(52) U.S. Cl. 370/338

(57) ABSTRACT

Wireless communication system comprising a master station, a first additional station, and a second additional station, whereby the master station is operable to communicate with the first and second additional stations in a first high-speed mode and a second low-speed mode, the first station is operable to communicate with the master station in the first mode and the second mode, and the second additional station is arranged to communicate in the second mode, characterized in that the first additional station is arranged to switch from the first mode to the second mode upon detection of a communication request from the second additional station to the first additional station.

The invention relates to a wireless communication system as defined in the preamble of claim 1.

The invention also relates to a station for use in a wireless communication system and a method of communication within a wireless communication system.

Such a wireless communication system is disclosed in IEEE Std. 802.11a, 1999, Wireless LAN Medium Access Control (MAC) and Physical (PHY) specifications: High Speed Physical Layer in the 5 GHz Band, IEEE, NY, 1999. A wireless communication system conforming this standard operates in the 5 GHz license free ISM band is able to support raw date rates ranging from 6 to 54 Mbit/sec using orthogonal frequency division multiplexing (OFDM). IEEE Std 802.11b discloses a similar communication system for operation in the 2.4 GHz ISM band. To satisfy the requirements of delay-bounded applications, a new specification has been proposed p802.11e incorporating data link layer functions to offer both statistic and parameterized QoS.

To support data rates up to about 100 Mbit/sec in the data link layer a new specification p802.11n will be proposed. In this proposal extensions to the 11a-based PHY and the 11e-based MAC standards are introduced, while keeping a certain level of backward compatibility. The PHY extensions are based on the support of multiple antenna systems (MIMO) and transmission in 40 MHz bands, so-called dual channel operation.

Wireless local area networks (WLANs) such as wireless communication systems compliant with one of the versions of IEEE Std. 802.11 or its proposed extensions are organized in cells or so-called basic service sets. Such cells comprise a number of wireless stations. One station within such a cell is arranged to provide communication with other cells, a master station or access point via an inter-cell system or distribution system. The additional stations are arranged to communicate with each other and stations in other cells via the access point.

In such a wireless communication facilitating a first mode for high-speed or high-throughput communication, while maintaining compatibility communication devices or stations capable of communicating in a second low-speed mode the master station has to be arranged to facilitate communication in both the first high-speed and the second low-speed mode. If the master station detects that an additional station communicates in the second mode, it will communicate with this additional station in the second mode, while it keeps communicating in the first mode with the additional station or station that are capable of communication in the first mode.

A disadvantage of this way of communicating is that the additional station communicating in the first mode cannot communicate directly with the additional station communicating in the second mode. Communication between them has to be routed via the master station, that has to translate the first mode communication into second mode communication and vice versa.

Amongst others it is an object of the invention to provide a wireless communication system and a method providing a higher degree of flexibility in communication between stations with the wireless communication system. A further object is to provide a wireless communication device providing a higher degree of flexibility in communication between stations with the wireless communication system.

To this end the invention provides a wireless communication system as defined in the opening paragraph of claim 1 which is characterized by the characterizing portion of claim 1. By allowing direct communication between the first additional station and the second additional station, it is not required that the master station translates first mode communication into second mode communication and vice versa.

If in addition the first additional station is arranged to communicate directly with the second additional station it is no longer required to route communication between them via the master station. This has the advantage that burden put upon the master station is reduced.

The object is also solved by a wireless communication device for use as a station in a wireless communication system, the wireless communication system further comprising a second station, and a master station, the wireless communication device is arranged to communicate with the master station in a first high-speed mode, wherein the wireless communication device is arranged to detect if the second station communicates with the master station in a second low-speed mode.

The object is further solved by a method according to claim 8.

The above and other objects and features of the present invention will become more apparent from the following detailed description considered in connection with the accompanying drawings in which:

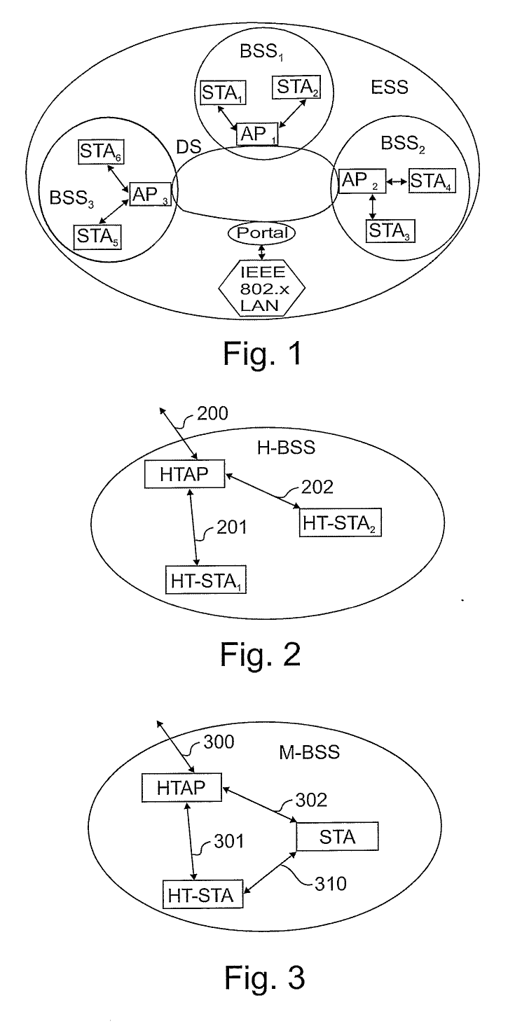

FIG. 1 shows a general overview of a communication system according to one of the group of IEEE Std. 802.11 specifications;

FIG. 2 shows an overview of a high throughput basic service set of a communication system;

FIG. 3 shows an overview of mixed basic service set of a communication system according to the invention.

In these figures identical parts are identified with identical references.

FIG. 1 shows a general overview of a communication system according to one of the group of IEEE Std. 802.11 specifications. The basic element in the network architecture is called the basic service set (BSS). A BSSₙ is defined as a group of stations (wireless nodes) which are located within a general limited physical area within which each station (STA) is theoretically capable of communicating with every other STA (assuming an ideal environment with no communication barriers, physical or otherwise). There are two basic wireless network design structures defined, ad hoc and infrastructure networks. An infrastructure-based IEEE 802.11 wireless network or communication system is composed of one or more BSSₙ which are interconnected through another network such as an IEEE 802.3 wired Ethernet network. This connecting infrastructure is called the Distribution System (DS). With this infrastructure each BSSₙ must have exactly one wireless station connected to the DS. This station provides the functionality to relay messages from the other STAs of the BSS to the DS. This STA is called the Access Point (AP) for its associated BSSₙ. The entity comprised of the DS and its connected BSSs is called an Extended Service Set (ESS). For the purposes of IEEE 802.11, the fact that the DS can move data between BSSs and to/from an external Portal is assumed, however the method used by the DS to accomplish this function is not defined.

An ad hoc wireless network is basically the opposite of an infrastructure-based wireless LAN (WLAN). An ad hoc WLAN has no infrastructure, and therefore no ability to communicate with external networks. An ad hoc WLAN is normally setup purely to permit multiple wireless stations STAs to communicate with each other while requiring as little external hardware or management support as possible. The BSS of an ad hoc network is referred to as an Independent BSS (IBSS), which is not illustrated.

A wireless communication system extending the existing IEEE 802.11 specifications, for instance a wireless communication system according to proposal P802.11n, while maintaining backward compatibility needs to support different modes of communication. To provide compatibility with legacy (IEEE 802.11a/g) devices, in infrastructure mode a basic service set BSS controlled by a P802.11n compliant high-throughput access point (HTAP) has three operating modes:

Pure mode: where legacy STAs cannot associate to the BSS; In this pure mode no legacy stations are present.

Managed-mixed mode: where legacy STAs can associate and the coexistence between high throughput (HT-STAs) and legacy STAs is managed by the HTAP through time division; There are two sub modes within the mixed managed mode. The first one is the mixed capable mode. In this mode there are no legacy stations, but the HTAP is able to accept the association from legacy stations that discover the HTAP or try to register at this HTAP, by receiving a legacy beacon from the HTAP. That means the beacon is sent out in an operation mode, which could be recognized by the legacy stations. The second mode is the managed mixed mode. In this mode the time is divided between contention free periods for HTSTA and legacy stations by selectively selecting the NAV (network allocation vector). The HTAP is transmitting headers which could be recognized by the legacy stations, wherein the header contains the time period of the data packet and/or the end of the data packet, thereby reserving a time in which the medium is blocked. Further the time for transmitting an acknowledgement signal is included in the header. Station receiving such header will set its NAV to the time of the end of the packet. So they will not access the medium during the signaled time. A part of the managed mixed mode may be the 20 MHz-Base managed mixed mode. In this mode the BSS contains both legacy and HT stations. There may be legacy stations of overlapping BSS in either or both of the channels. Legacy and HT stations associate to the AP's BSS in the control channel. The AP manages the generation of 40 MHz or HT periods and 20 MHz or low speed periods. During the 40 MHz period HT stations are allowed to access the medium in 40 MHz. The legacy stations are not allowed to access the medium at this time. During the 20 MHz period legacy stations are allowed to access the medium in 20 MHz.

Unmanaged mixed mode: where legacy STAs can associate and the coexistence is not managed by the HTAP.

The high-throughput stations HT-STAs may also operate in three different modes:

Pure mode: the STA communication does not require protection of high-throughput frames;

Mixed mode: this mode provides a protection mechanism of legacy communication (spoofing, etc.);

Legacy mode: in this mode the STA communicates as if it where a legacy station.

In a managed-mixed BSS and a pure BSS the high-throughput HT-STA uses the Pure mode. In an unmanaged BSS the high-throughput STA uses the mixed mode. The Legacy mode is used if no HTAP is detected.

FIG. 2 shows an overview of a high throughput basic service set (H-BSS) of a communication system extending the existing IEEE 802.11 specifications. The shown H-BSS comprises three stations, a High-Throughput Access Point (HTAP), and two other High-Throughput stations HTSTA1 and HTSTA2. The shown H-BSS may be for instance a wireless communication system according to proposal P802.11n operating in infrastructure mode. Within the high throughput basic service set H-BSS the first high throughput station HTSTA1 communicates with high throughput access point HTAP via a first high throughput communication link 201. The second high throughput station HTSTA2 communicates with high throughput access point HTAP via a second high throughput communication link 202. High throughput access point HTAP is connected to a not illustrated distribution system via communication link 200.

FIG. 3 shows an overview of mixed basic service set (M-BSS) of a communication system according to the invention. The shown M-BSS comprises a High-Throughput Access Point (HTAP), a High-Throughput station (HT-STA), and a station (STA) compliant with a legacy communication standard. Therefore the legacy STA can only communicate in a low-speed mode, while both the HTAP and the HT-STA can communicate both in a high-speed mode and the low-speed mode.

In a known way of communicating with each other, HTAP and HT-STA would communicate in for instance compliant with P802.11n. The HTAP operates in the managed mixed mode or the unmanaged mixed mode. In both cases a high-speed communication link 301 can be established between HTAP and HT-STA. If HTAP operates in the managed mixed mode HT-STA will operate in the pure mode. If HTAP operates in the unmanaged mixed mode HT-STA will operate in the mixed mode. Thus the mode of operation of HT-STA is determined by the mode of operation of HTAP.

HTAP and legacy STA will communicate with each other in a low-speed mode on communication link 302. HTAP will communicate via communication link 300 and the distribution system to other basic service sets.

A disadvantage of this way of communicating is that no direct communication link can be established between HT-STA and STA, since both communicate in a different mode. To decrease the burden put upon the HTAP in such mixed basic service sets (with high throughput and legacy stations) preferably a possibility to establish direct communication links 310 between a HT-STA and a STA is therefore created in the wireless communication system according to the invention. At least in the system according to the invention the HT-STA may switch between high-speed communication and low-speed operation independent of the mode of operation of the HTAP.

In the system according to the invention a HT-STA is able to change between only pure mode to a dual pure/legacy mode or between only mixed mode to dual mixed/legacy mode within a mixed BSS (either managed or unmanaged). Through the reception of beacons, transmitted by the HTAP, indicating inter alia its mode of operation the HT-STA is able to distinguish if it is associated to a Pure or Mixed basic service set. In case the HT-STA is associated to a mixed basic service set M-BSS and a direct communication link 310 between the HT-STA and a legacy STA, the HT-STA will use a legacy mode of operation, e.g. IEEE 802.11a or 11g, with low-speed communication e.g. based on 20 MHz channel to communicate with the legacy STA. This is required, since the STA cannot communicate in a high-speed mode. The HT-STA can detect a legacy STA during the direct link protocol (DLP), which is also called direct link setup (DLS) according to the IEEE 802.11e by reading the supported rates and extended capabilities fields of the DLP request and DLP response frames. Both the HT-STA and the legacy STA may request a direct link 310 to communicate directly.

In for instance a wireless communication system compliant with IEEE P802.11n a communication channel or link is created by combining two or more IEEE 802.11a or 11g communication channels. Each 802.11a or 11g communication channel comprises a 20 MHz band. In P802.11n two neighboring bands (in principle more than two is also possible) are combined into one high-speed communication channel. In case the HT-STA communicates in a low-speed mode with the STA via direct link 310, there is still room to establish a second direct low-speed communication link with a second STA or even more if one high-speed communication link requires the combination of more than two low-speed communication channels. To establish more than one low-speed communication link simultaneously will in most situations require that the HT-STA is equipped with dual or in general with multiple transceivers to facilitate operation on multiple channels in parallel.

The embodiments of the present invention described herein are intended to be taken in an illustrative and not a limiting sense. Various modifications may be made to these embodiments by those skilled in the art without departing from the scope of the present invention as defined in the appended claims.

For instance, although the invention is discussed in relation with a wireless communication system based on IEEE Std. 802.11, it will be obvious to a skilled person that this is not required and that the wireless communication system according to the invention may other specifications.

1. A wireless communication system comprising a master station, a first additional station, and a second additional station, whereby the master station is operable to communicate with the first and second additional stations in a first high-speed mode and a second low-speed mode, the first station is operable to communicate with the master station in the first mode and the second mode, and the second additional station is arranged to communicate in the second mode, wherein the first additional station is arranged to switch from the first mode to the second mode upon detection of a communication request from the second additional station to the first additional station.

2. A wireless communication system as claimed in claim 1, characterized in that the first additional station is arranged to establish a direct communication link with the second additional station.

3. A wireless communication system as claimed in claim 1, characterized in that the communication in the second mode is compliant with IEEE Std. 802.11a, IEEE Std. 802.11b, or IEEE Std. 802.11g.

4. A wireless communication device for use as a station in a wireless communication system, the wireless communication system further comprising a second station, and a master station, whereby the wireless communication device is arranged to communicate with the master station in a first high-speed mode, wherein the wireless communication device is arranged to detect if the second station communicates with the master station in a second low-speed mode.

5. A wireless communication device as claimed in claim 4, characterized in that the device is arranged to switch from the first mode to the second mode upon detection of a communication request from the second additional station to the first additional station.

6. A wireless communication device as claimed in claim 4, characterized in that it is arranged to establish a direct communication link with the second station.

7. A wireless communication device as claimed in claim 4, characterized in that the communication in the second mode is compliant with IEEE Std. 802.11a, IEEE Std. 802.11b, or IEEE Std. 802.11g.

8. A method of communication within a wireless communication system comprising a master station, a first additional station, and a second additional station, whereby the master station communicates with the first and second additional stations in a first high-speed mode and a second low-speed mode respectively, the first station communicates with the master station in the first mode, and the second additional station communicates in the second mode, wherein the first additional station switches from the first mode to the second mode upon detection of a communication request from the second additional station to the first additional station.
